(19) United States
(12) Patent Application Publication
(10) Pub. No.: US 2020/0009586 A1
(43) Pub. Date: Jan. 9, 2020

(54) HAND-HELD WATER DISPENSING APPARATUS

(71) Applicant: Walmart Apollo, LLC, Bentonville, AR (US)

(72) Inventors: Yurgis Mauro Bacallao, Centerton, AR (US); Nicholas Hoyne, Rogers, AR (US)

(21) Appl. No.: 16/459,872

(22) Filed: Jul. 2, 2019

Related U.S. Application Data
(60) Provisional application No. 62/693,525, filed on Jul. 3, 2018.

(51) Int. Cl. B05B 1/16; B05B 1/20

(52) U.S. Cl. CPC B05B 1/1672; B05B 12/002; B05B 1/20

(57) ABSTRACT

A water dispensing apparatus comprises a first tubular elongated element including a first inlet at a proximal end of the first tubular elongated element, an outlet at a distal end of the first tubular elongated element, and an uninterrupted first flow path extending from the inlet to the outlet for outputting a source of fluid to the outlet; a second tubular elongated element including a second inlet at a proximal end of the second tubular elongated element, a second flow path extending along a length of the second tubular elongated element from the inlet in the longitudinal direction, and a plurality of outlets along the length of the second tubular elongated element for outputting a source of fluid; a nozzle coupled to the outlet of the first tubular elongated element; and a control valve system coupled to each of the first and second inlets.

### RELATED APPLICATIONS

This application claims the benefit of U.S. Provisional Patent No. 62/693,525, filed Jul. 3, 2018, entitled “Hand-held Water Dispensing Apparatus,” the contents of which are incorporated herein in its entirety.

### TECHNICAL FIELD

The technical field generally relates to lawn and garden tools. More particularly, the technical field relates to multi-purpose tools for dispensing fluids such as water according to user-selectable output patterns.

### BACKGROUND

Conventional hand-held watering wands are single-purpose sprayers, namely, configured with a showerhead for watering plants from a location about the plants so that the water drops fall into the leaves, soil, roots, etc. by way of gravity. Some lawn and garden centers, greenhouses, nurseries, or other plant suppliers water their plants by automatically providing water via mats on which the plants are positioned, so that the plants absorb the water from a region beneath the plants.

### BRIEF SUMMARY

In one aspect, a water dispensing apparatus comprises a first tubular elongated element extending in a longitudinal direction, the first tubular elongated element including a first inlet at a proximal end of the first tubular elongated element, an outlet at a distal end of the first tubular elongated element, and an uninterrupted first flow path extending from the inlet to the outlet for outputting a source of fluid to the outlet; a second tubular elongated element extending in the longitudinal direction, the second tubular elongated element including a second inlet at a proximal end of the second tubular elongated element, a second flow path extending along a length of the second tubular elongated element from the inlet in the longitudinal direction, and a plurality of outlets along the length of the second tubular elongated element for outputting a source of fluid, each outlet in direct communication with the second flow path; a nozzle coupled to the outlet of the first tubular elongated element; and a control valve system coupled to each of the first and second inlets. The control valve system comprises an inlet for receiving a flow of fluid from a fluid source; an outlet that outputs a flow of the source of fluid to at least one of the first and second tubular elongated elements; a first valve for controlling a flow of the source of fluid through the uninterrupted first flow path of the first tubular elongated element; and a second valve for controlling a flow of the source of fluid through the second flow path of the second tubular elongated element.

One or more of the following features may be included:

In some embodiments, the nozzle provides a first output of the source of water directed in a first direction, and the holes in the perforated pipe section provide a second output of the source of water directed in a second direction transverse to the first direction.

In some embodiments, the water dispensing apparatus further comprises a trigger mechanism for opening and closing a fluid path from the inlet to the outlet of the dual-valve mechanism for a user-controlled amount of time.

In some embodiments, the trigger mechanism includes a locking mechanism that is selected by the user to position a trigger of the triggering mechanism in a position of interest by the user for outputting the source of fluid to at least one of the first and second tubular elongated elements.

In some embodiments, the first and second valves of the control valve system are one-way valves, wherein each one-way valve controls a flow path of fluid to one of the first and second tubular elongated elements.

In some embodiments, the first and second valves of the control valve system are part of a single multi-valve unit.

In some embodiments, the water dispensing apparatus further comprises a handle which at least partially surrounds the single multi-valve unit.

In some embodiments, the water dispensing apparatus further comprises a handle coupled to each of the proximal ends of first and second tubular elongated elements, wherein the handle includes the control valve system.

In some embodiments, the water dispensing apparatus further comprises a handle positioned about the proximal end of the first tubular elongated element.

In some embodiments, the water dispensing apparatus further comprises at least one coupling mechanism constructed and arranged for directly attaching to a surface that permits the water dispensing apparatus to be suspended so that the outlets of the second tubular apparatus are positioned over a predetermined region for receiving the source of fluid from the second tubular elongated element.

In another aspect, a water dispensing apparatus comprises a first tubular elongated element extending in a longitudinal direction, the first tubular elongated element including a first inlet at a proximal end of the first tubular elongated element, an outlet at a distal end of the first tubular elongated element, and an uninterrupted first flow path extending from the inlet to the outlet for outputting a source of fluid to the outlet; a second tubular elongated element extending in the longitudinal direction, the second tubular elongated element including a second inlet at a proximal end of the second tubular elongated element, a second flow path extending along a length of the second tubular elongated element from the inlet in the longitudinal direction, and a plurality of outlets along the length of the second tubular elongated element for outputting a source of fluid, each outlet in direct communication with the second flow path; and a handle coupled to the proximal ends of the first and second tubular elongated elements, the handle including a control valve mechanism that controls a flow of the source of fluid through at least one of the first or second tubular elongated elements.

One or more of the following features may be included:

In some embodiments, the water dispensing apparatus further comprises a nozzle at the outlet of the first tubular elongated element.

In some embodiments, the distal end of the first tubular elongated element includes a region of curvature such that outlets of the nozzle are tangential to the second tubular elongated element.

In some embodiments, the water dispensing apparatus further comprises a trigger mechanism for opening and closing a fluid path from the inlet to the outlet of the control valve mechanism for a user-controlled amount of time.

In some embodiments, the trigger mechanism includes a locking mechanism that is selected by the user to position a trigger of the triggering mechanism in a position of interest by the user for outputting the source of fluid to at least one of the first and second tubular elongated elements.

In some embodiments, the control valve mechanism includes first and second one-way valves, wherein each one-way valve controls a flow path of fluid to one of the first and second tubular elongated elements.

In some embodiments, the water dispensing apparatus further comprises at least one coupling mechanism constructed and arranged for directly attaching to a surface that permits the water dispensing apparatus to be suspended so that the outlets of the second tubular apparatus are positioned over a predetermined region for receiving the source of fluid from the second tubular elongated element.

In another aspect, a water dispensing apparatus comprises a first tubular elongated element extending in a longitudinal direction, the first tubular elongated element including a first inlet at a proximal end of the first tubular elongated element, an outlet at a distal end of the first tubular elongated element, and an uninterrupted first flow path extending from the inlet to the outlet for outputting a source of fluid to the outlet; a second tubular elongated element extending in the longitudinal direction, the second tubular elongated element including a second inlet at a proximal end of the second tubular elongated element, a second flow path extending along a length of the second tubular elongated element from the inlet in the longitudinal direction, and a plurality of outlets along the length of the second tubular elongated element for outputting a source of fluid, each outlet in direct communication with the second flow path; a threaded inlet at the first and second tubular elongated element inlets; a handle about the first tubular elongated element; and a control valve mechanism that controls a flow of the source of fluid through at least one of the first or second tubular elongated elements.

One or more of the following features may be included:

In some embodiments, the water dispensing apparatus further comprises a nozzle at the outlet of the first tubular elongated element.

In some embodiments, the control valve mechanism comprises a first selection lever for controlling a flow of the source of fluid through the uninterrupted first flow path of the first tubular elongated element; and a second selection lever for controlling a flow of the source of fluid through the second flow path of the second tubular elongated element.

### BRIEF DESCRIPTION OF THE DRAWINGS

The above and further aspects of examples of the present inventive concepts may be better understood by referring to the following description in conjunction with the accompanying drawings, in which like numerals indicate like structural elements and features in various figures. The drawings are not necessarily to scale, emphasis instead being placed upon illustrating the principles of features and implementations.

FIG. 1 depicts a perspective view of a water dispensing apparatus, in accordance with some embodiments.

FIG. 2 depicts a perspective view of a water dispensing apparatus, in accordance with other embodiments.

FIG. 3 depicts a cross-sectional view of a water volume control valve of a water dispensing apparatus, in accordance with some embodiments.

FIG. 4 is a view of a trigger mechanism of the water volume control valve of FIGS. 1-3, in accordance with some embodiments.

FIG. 5 is a view of a water dispensing apparatus remotely controlled by an electronic device, in accordance with some embodiments.

FIG. 6 is a flow diagram of a method for hands-free operation of a water dispensing apparatus, in accordance with some embodiments.

### DETAILED DESCRIPTION

In brief overview, disclosed are embodiments of a water dispensing apparatus that permits a user to operate the apparatus in a hands-free manner, and in one of two different modes of operation. The first mode permits the apparatus to dispense water from a nozzle. The second mode permits the apparatus to dispense water from a shower-like arrangement so that a wider area can receive an output from the apparatus than from the nozzle. Accordingly, the apparatus is constructed and arranged for watering hanging plants, individual plants, garden regions, or other various surface areas comprising plants.

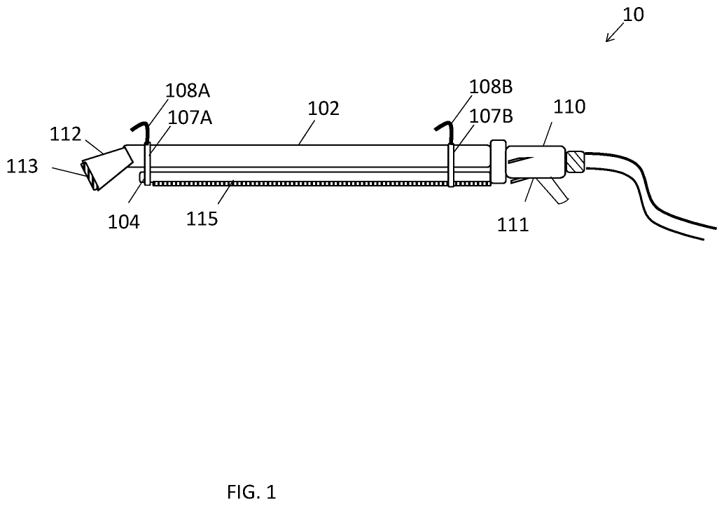

FIG. 1 depicts a perspective view of a water dispensing apparatus 10, in accordance with some embodiments. The water dispensing apparatus 10, also referred to as a watering wand, is constructed and arranged for hand-held portable use, for example, by a user who desires to water plants, grass, vegetables, and/or other organic members of the plant kingdom.

The watering wand 10 may include a first tubular body 102, a second tubular body 104, and a handle 110 including a water volume control valve 111 that controls a flow of fluid such as water through the first tubular body 102 and the second tubular body 104.

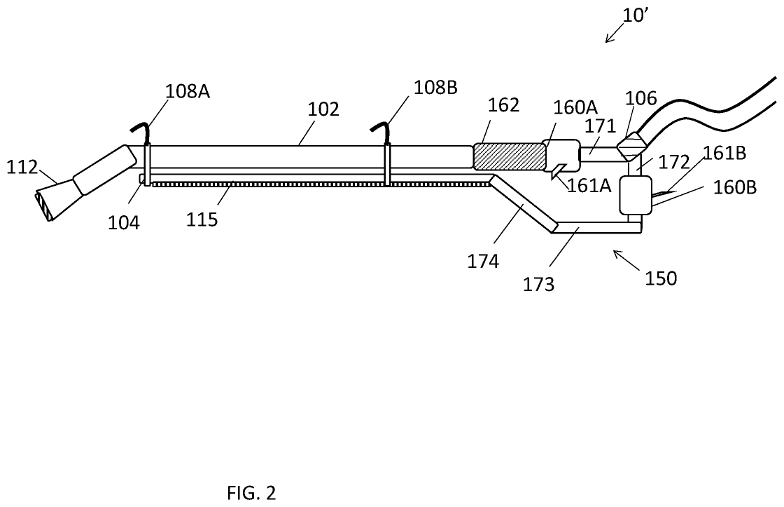

The first tubular body 102 is generally elongated from its proximal end to its distal end. In some embodiments, as shown in FIG. 1, the first tubular body 102 has a nozzle 112 that is coupled to a distal end of the first tubular body 102 so that a fluid path, also referred to as a first fluid path, extends through the interior of the first tubular body 102 to the nozzle 112, which outputs some or all fluid in the fluid path through a plurality of holes 113 that form channels that extend from the fluid path through the nozzle 112 for outputting water or other fluid. In some embodiments, the nozzle 112 is fixedly coupled the distal end of the first tubular body 102 at an angle relative to the direction of extension of the first tubular body 102. In other embodiments, as shown in FIG. 2, the first tubular body 102 itself has a bend, for example, a curved distal end, whereby a nozzle 112 is coupled to the bent tubular body 102. In other embodiments, a pivotable joint is coupled between the nozzle 112 and the first tubular body 102 for movably rotating the nozzle 112 relative to the first tubular body 102 to a desired position. The purpose of the nozzle 112 angled relative to the first tubular body 102 is to allow a user to hold the first tubular body 102 and/or handle 110 in a horizontal position while directing the outlet of the nozzle 112 at plants or other desired target for watering.

In some embodiments, the fluid path extending in the direction of extension through the interior of the first tubular body 102 is uninterrupted from the proximal end coupled to the handle control valve 111 to the distal end coupled to the nozzle 112. In particular, each of the proximal end and the distal end of the first tubular body 102 has an opening so that water or other fluid can flow through an inlet at the proximal end through the channel extending through the interior of the length of the first tubular body 102 to an outlet at the distal end for output via the nozzle 112 in communication with the outlet.

The second tubular body 104 is also generally elongated from its proximal end to its distal end, and may extend along a same longitudinal axis as the first tubular body 102 so as to be parallel to the first tubular body 102. The second tubular body 104 may likewise have an inlet 221 at its proximal end for receiving a flow of water or other fluid from a common source such as an inlet 106 of the control valve 111. The inlet 106 may include threads, gaskets, and/or or other coupling mechanism for providing a secure and fluid-tight interface with a garden hose or other source of water or other fluid.

Unlike the first tubular body 102, some embodiments of the second tubular body 104 do not include an outlet at its distal end, since the second tubular element includes a plurality of holes 115 for outputting water along a length of the body 104. Other embodiments include an outlet in the second tubular body 104 that extend the fluid path in the second tubular body 104 to a portion of the first tubular body 102 such as a distal end of the first tubular body 102 or to the nozzle 112 so that a portion of water flowing through the second tubular body 104 is also output from the nozzle 112.

As mentioned above, the second tubular body 104 has a plurality of holes 115, also referred to as channels, perforations, and so on that extend along a length of the second tubular body 104. The holes/channels 115 extend from the fluid path extending through the interior of the second tubular body 104 to the outer surface of the second tubular body 104 so that fluid can be output via the holes/channels 115 to plants or the like positioned below the second tubular body 104, for example, outputting a curtain of water from the holes/channels 115 extending along a length of the second tubular body 104. In some embodiments, the holes 115 are configured with spraying elements, such as jet sprayers or devices that can adjust the size of the holes 115.

As shown in FIG. 1, the first tubular body 102 and the second tubular body 104 may each be coupled to a common handle 110, which includes a control valve system 111 for controlling a volume of fluid through the first tubular body 102 and the second tubular body 104, respectively. In some embodiments, the first tubular body 102 and the second tubular body 104 may each be coupled to one or more connectors 107A, 107B (generally, 107) for providing additional stability to the watering wand apparatus 10. In some embodiments, the control valve system 111 includes multiple one-way valves, each controlling a fluid flow through the first tubular body 102, the second tubular body 104, or a common flow path that outputs fluid to flow paths of the first and/or second tubular bodies 102, 104. In other embodiments, the control valve 111 includes at least one two-way valve, for example, a two direction ball valve, for toggling between the nozzle 112 and curtain formed by the layout of holes 115, or spared openings along the length of the second tubular body 102. The spacing of the outlet openings 115 is determined by the diameter of the holes 115. The openings 115 can be in a single line or in a plurality of rows or other arrangement.

In other embodiments, as shown in FIG. 2, an inlet assembly 150 may have an inlet assembly 150 that has two pipe portions extending from the threaded inlet 106. The first pipe portion extends from the inlet 106 through a first control valve 160A to the first tubular body 102. A handle grip 162 may be positioned about the first tubular body 102 so that a user can operate the watering apparatus 10′. The first control valve 160A controls a flow of fluid from the inlet 106 to the first tubular body 102. The second pipe portion extends from the inlet 106 through a second control valve 160B to the second tubular body 102. The second control valve 160B controls a flow of fluid from the inlet 106 to the second tubular body 104. As shown in FIG. 2, in some embodiments, the first control valve 160A includes a selection lever 161A that permits a user to manually control a valve, switch, or other mechanism along the flow path of the first tubular body 102 to permit or impede a flow of fluid. Similarly, the second control valve 160B includes a selection lever 161B that permits a user to manually control a valve, switch, or other mechanism along the flow path of the second tubular body 104 to permit or impede a flow of fluid. In other embodiments, for example, described herein, the valves, switches, and so on along the flow paths of the tubular bodies 102, 104 are controlled by electro-mechanical or computer-based control signals. In some embodiments, both selection levers 161A, 161B extend from a common body, such as a two-way valve similar to FIG. 1, wherein the inlet 106 and two output pipe portions 171, 172 are coupled to the same common body. Other configurations may equally apply so long as a user is provided an option of selecting the flow of fluid through one pipe section at a time, including control valves, levers, switches, and so on at any or all pipe sections 171-174.

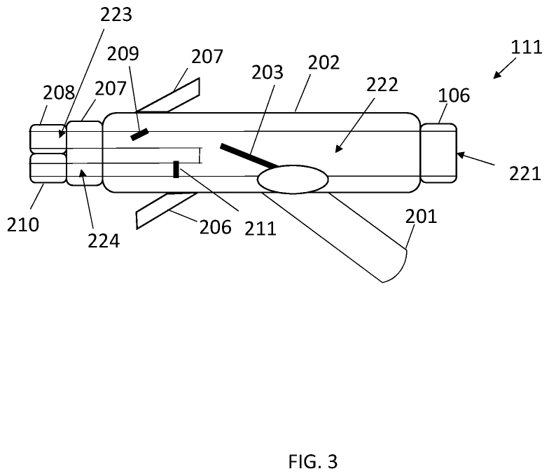

In some embodiments, the watering apparatus 10 of FIG. 1 or the watering apparatus 10′ of FIG. 2 may include one or more hooks 108A, 108B (generally, 108) or other coupling elements that each is coupled to and extends from a connector 107 or the first tubular body 102 and constructed and arranged for positioning about an elongated base element such as a rod, tree limb, and so on for suspending the watering wand 10 over a region of interest. Although hooks are shown and described, these coupling elements are not limited thereto. For example, the coupling elements can be magnets, clamps, screws, and so on. The hooks 108 are positioned to accommodate for weight distribution of the apparatus 10, including the weight of a hose coupled to the apparatus 10. Here, when suspended in this manner, the watering wand 10 can function as a shower where water exiting the holes 115 in the second tubular apparatus 104 can be output directly to plants, grass, and so on. In some embodiments, a flow path may automatically be formed from the opening 221 at the inlet 106 to the holes 115 in the second tubular apparatus 104 due to the position of switches, levers, and other mechanical elements of the handle control valve 110 when the watering wand 10 is suspended. For example, one or more hooks 108 may include a sensor, or be movably coupled to an actuator, electrical or computer-based controller, or other mechanical device that in turn controls the combination of switches, valves, or the like 203, 209, 211 (see FIG. 3) to form the desired fluid path, which outputs water or other fluid in a linear or curtain-like format through the second tubular apparatus holes 115. For example, the watering wand 10 may include a special purpose hardware computer processor that is programmed to control the movement and arrangement of the switches 203, 209, 211. In other embodiments, such a flow path is formed by a manual control of the arrangement of switches 203, 209, 211.

As shown in FIG. 3, the control valve 111 may include a trigger 201, a first water selection lever 206, and a second water selection lever 207, each configured to articulate relative to a handle body 202.

The trigger 201, when pressed, squeezed, or otherwise has a force applied to it, translates to a movement of a switch mechanism 203 such as a valve, spring, actuator, and/or other mechanisms that block the flow path 222 through the handle body so that water or other fluid cannot flow from the opening 221 to either a flow path 223 to the first tubular apparatus 202 or a flow path 224 to the second tubular apparatus 224. Similarly, the first lever 206 functions as a switch, which controls a switch mechanism 209 such as valve, spring, actuator, and/or other mechanism that in turn blocks the flow path 223 to the first tubular apparatus. An interface 208 may be at a distal end of the handle 110 for coupling to the first tubular apparatus 202 and extending the flow path 223 to the first tubular apparatus 202. Similarly, the second lever 207 functions as a switch, which controls a switch mechanism 211 such as valve, spring, actuator, and/or other mechanism that in turn blocks the flow path 224 to the first tubular apparatus. An interface 210 may be at a distal end of the handle 110 for coupling to the second tubular apparatus 204 and extending the flow path 224 to the second tubular apparatus 204.

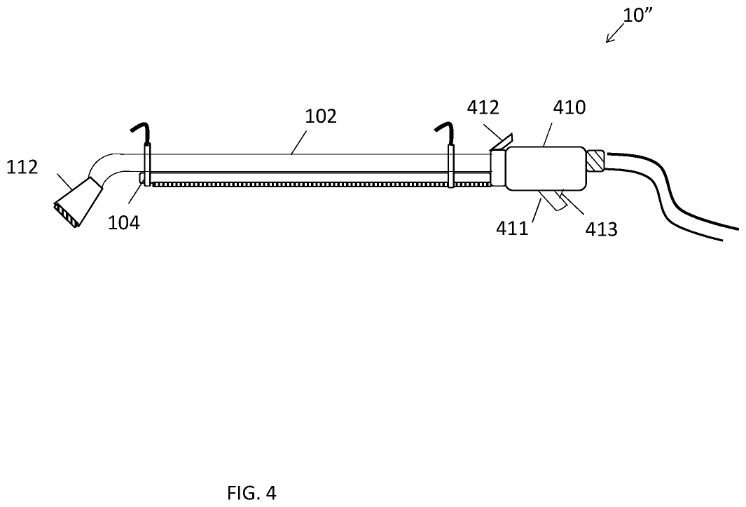

In some embodiments, as shown in FIG. 4, a watering wand 10″ may include a control valve 410 configured with a lockable trigger 411. The watering wand 10″, as with other water dispensing devices described in embodiments herein, may be used by gardeners or other users which connect the control valve 410 to a threaded connector end of a standard garden hose. This configuration permits for the hose to output a source of pressurized fluid, e.g., water, to the control valve 410, which in turn controls via its arrangement of valves, switches, and the like to output the water to the first or second elongated tubular elements 102, 104, respectively.

The control valve 410 includes a trigger mechanism 413 to actuate a valve such as valve 203 shown in FIG. 3 which controls the flow of water through the flow path 222 extending through the length of the control valve 410. The trigger mechanism 413 and valves are configured to permit the flow of water to be infinitely varied from no flow to full flow, depending on the position and/or orientation of the trigger 411. In some embodiments, the trigger mechanism 413 includes a locking mechanism that is selected by the user to hold the trigger 411 in a position of interest by the user.

Also referring to FIG. 4, a watering wand 10″ may include a single lever 412 or related mechanical selector, also referred to as a water selector, that selects either the first tubular apparatus 102 so that water flows through the nozzle 112 or the second tubular apparatus so that water flows through the holes 115. Although not shown in FIG. 3, the single lever 412 can control a movement of either or both of the valve 209 or valve 211 according to the desired flow of water through the watering wand 10″. In other embodiments, a three-way valve is provided for controlling the flow of water through flow paths 223 and/or 224.

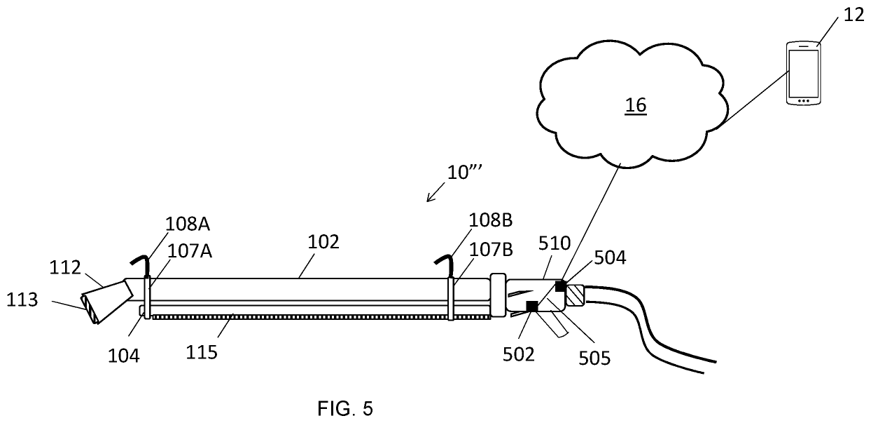

As shown in FIG. 5, a watering wand 10′″ in some embodiments includes a network interface 504 that permits remote data commands to be received from a mobile device 12 or other remote computer via a network 16 for controlling the trigger 411 and/or selectors described in FIG. 3 or FIG. 4. In some embodiments, the trigger mechanism 510 includes a special purpose hardware processor 502 that stores data that controls via electronic signals the trigger and/or lock for programming the location of the trigger which in turn controls the flow of water according to data commands. The mobile device 12 or other remote computer communicates with the processor 502 via the network interface 504 that in turn communicates with the processor 502 via a connector 506, for example, a wired connection. In some embodiments, the processor 502 includes a timing device that controls the trigger mechanism 510 and/or control valves to output a source of water for a predetermined amount of time, for example, in a hands-free operation, or when the apparatus 10′″ is suspended by its hooks 108.

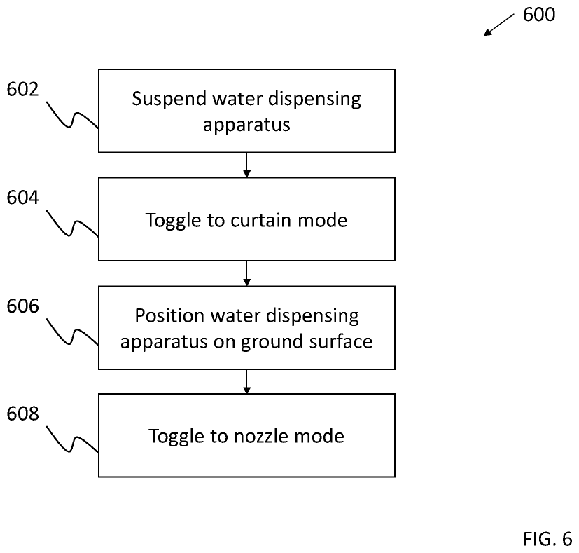

FIG. 6 is a flow diagram of a method 600 for hands-free operation of a water dispensing apparatus, in accordance with some embodiments.

At block 602, a wand dispensing apparatus 10, 10′, 10″, 10′″ (generally 10) is suspended from a beam or other object capable of supporting the weight of the apparatus 10 and a hose coupled to the apparatus 10.

At block 604, the wand dispensing apparatus 10 is configured for a curtain mode, where water or other fluid is output from the holes 10 in the second tubular apparatus 104. For example, embodiments of levers, switches, remote data commands, or other mechanical or electrical techniques for directing a flow of water or other fluid to the second tubular apparatus 104. In the curtain mode, the water is spread evenly along its length, and therefore distributes the water evenly to plants below the apparatus 10. In some embodiments, a shower mat or the like is under the plants for receiving the water from the holes 115, where a capillary action occurs to distribute the water to the plants.

At block 606, the wand dispensing apparatus 10 is positioned on a surface, such as a ground, table, and so on.

At block 608, the wand dispensing apparatus 10 is configured for a nozzle mode, where water or other fluid is output from the nozzle holes 113 in the first tubular apparatus 102. For example, embodiments of levers, switches, remote data commands, or other mechanical or electrical techniques for directing a flow of water or other fluid to first second tubular apparatus 102, which permits a showerhead nozzle or the like to provide directed manual spraying.

A number of implementations have been described. Nevertheless, it will be understood that the foregoing description is intended to illustrate, and not to limit, the scope of the inventive concepts which are defined by the scope of the claims. Other examples are within the scope of the following claims.

What is claimed is:

1. A water dispensing apparatus, comprising:
a first tubular elongated element extending in a longitudinal direction, the first tubular elongated element including a first inlet at a proximal end of the first tubular elongated element, an outlet at a distal end of the first tubular elongated element, and an uninterrupted first flow path extending from the inlet to the outlet for outputting a source of fluid to the outlet;
a second tubular elongated element extending in the longitudinal direction, the second tubular elongated element including a second inlet at a proximal end of the second tubular elongated element, a second flow path extending along a length of the second tubular elongated element from the inlet in the longitudinal direction, and a plurality of outlets along the length of the second tubular elongated element for outputting a source of fluid, each outlet in direct communication with the second flow path;
a nozzle coupled to the outlet of the first tubular elongated element; and
a control valve system coupled to each of the first and second inlets, comprising:
an inlet for receiving a flow of fluid from a fluid source;
an outlet that outputs a flow of the source of fluid to at least one of the first and second tubular elongated elements;
a first valve for controlling a flow of the source of fluid through the uninterrupted first flow path of the first tubular elongated element; and
a second valve for controlling a flow of the source of fluid through the second flow path of the second tubular elongated element.

2. The water dispensing apparatus of claim 1, wherein the nozzle provides a first output of the source of water directed in a first direction, and the holes in the perforated pipe section provide a second output of the source of water directed in a second direction transverse to the first direction.

3. The water dispensing apparatus of claim 1, further comprising a trigger mechanism for opening and closing a fluid path from the inlet to the outlet of the control valve system for a user-controlled amount of time.

4. The water dispensing apparatus of claim 1, wherein the trigger mechanism includes a locking mechanism that is selected by the user to position a trigger of the triggering mechanism in a position of interest by the user for outputting the source of fluid to at least one of the first and second tubular elongated elements.

5. The water dispensing apparatus of claim 1, wherein the first and second valves of the control valve system are one-way valves, wherein each one-way valve controls a flow path of fluid to one of the first and second tubular elongated elements.

6. The water dispensing apparatus of claim 1, wherein the first and second valves of the control valve system are part of a single two-way valve unit, and wherein each valve of the two-way valve unit controls a pipe portion of the first or second tubular elongated elements.

7. The water dispensing apparatus of claim 6, further comprising a handle which at least partially surrounds the single multi-valve unit.

8. The water dispensing apparatus of claim 1, further comprising a handle coupled to each of the proximal ends of first and second tubular elongated elements, wherein the handle includes the control valve system.

9. The water dispensing apparatus of claim 1, further comprising a handle positioned about the proximal end of the first tubular elongated element.

10. The water dispensing apparatus of claim 1, further comprising at least one coupling mechanism constructed and arranged for directly attaching to a surface that permits the water dispensing apparatus to be suspended so that the outlets of the second tubular apparatus are positioned over a predetermined region for receiving the source of fluid from the second tubular elongated element.

11. A water dispensing apparatus, comprising:
a first tubular elongated element extending in a longitudinal direction, the first tubular elongated element including a first inlet at a proximal end of the first tubular elongated element, an outlet at a distal end of the first tubular elongated element, and an uninterrupted first flow path extending from the inlet to the outlet for outputting a source of fluid to the outlet;
a second tubular elongated element extending in the longitudinal direction, the second tubular elongated element including a second inlet at a proximal end of the second tubular elongated element, a second flow path extending along a length of the second tubular elongated element from the inlet in the longitudinal direction, and a plurality of outlets along the length of the second tubular elongated element for outputting a source of fluid, each outlet in direct communication with the second flow path; and
a handle coupled to the proximal ends of the first and second tubular elongated elements, the handle including a control valve mechanism that controls a flow of the source of fluid through at least one of the first or second tubular elongated elements.

12. The water dispensing apparatus of claim 11, further comprising a nozzle at the outlet of the first tubular elongated element.

13. The water dispensing apparatus of claim 12, wherein the distal end of the first tubular elongated element includes a region of curvature such that outlets of the nozzle are tangential to the second tubular elongated element.

14. The water dispensing apparatus of claim 11, further comprising a trigger mechanism for opening and closing a fluid path from the inlet to the outlet of the control valve mechanism for a user-controlled amount of time.

15. The water dispensing apparatus of claim 11, wherein the trigger mechanism includes a locking mechanism that is selected by the user to position a trigger of the triggering mechanism in a position of interest by the user for outputting the source of fluid to at least one of the first and second tubular elongated elements.

16. The water dispensing apparatus of claim 11, wherein the first and second valves of the control valve system are part of a single two-way valve unit, and wherein each valve of the two-way valve unit controls a pipe portion of the first or second tubular elongated elements.

17. The water dispensing apparatus of claim 11, further comprising at least one coupling mechanism constructed and arranged for directly attaching to a surface that permits the water dispensing apparatus to be suspended so that the outlets of the second tubular apparatus are positioned over a predetermined region for receiving the source of fluid from the second tubular elongated element.

18. A water dispensing apparatus, comprising:
a first tubular elongated element extending in a longitudinal direction, the first tubular elongated element including a first inlet at a proximal end of the first tubular elongated element, an outlet at a distal end of the first tubular elongated element, and an uninterrupted first flow path extending from the inlet to the outlet for outputting a source of fluid to the outlet;
a second tubular elongated element extending in the longitudinal direction, the second tubular elongated element including a second inlet at a proximal end of the second tubular elongated element, a second flow path extending along a length of the second tubular elongated element from the inlet in the longitudinal direction, and a plurality of outlets along the length of the second tubular elongated element for outputting a source of fluid, each outlet in direct communication with the second flow path;
a threaded inlet at the first and second tubular elongated element inlets;
a handle about the first tubular elongated element; and
a control valve mechanism that controls a flow of the source of fluid through at least one of the first or second tubular elongated elements.

19. The water dispensing apparatus of claim 18, further comprising a nozzle at the outlet of the first tubular elongated element.

20. The water dispensing apparatus of claim 18, wherein the control valve mechanism comprises a first selection lever for controlling a flow of the source of fluid through the uninterrupted first flow path of the first tubular elongated element; and a second selection lever for controlling a flow of the source of fluid through the second flow path of the second tubular elongated element.
